(19) United States
(12) Patent Application Publication
(10) Pub. No.: US 2011/0302887 A1
(43) Pub. Date: Dec. 15, 2011

(54) SOY-BASED MODELING PRODUCT

(76) Inventors: Sawyer Sparks, Bloomfield, IN (US); Sue Ellen Sparks, Bloomfield, IN (US)

(21) Appl. No.: 13/203,433

(22) PCT Filed: Feb. 26, 2010
(86) PCT No.: PCT/US2010/025581

§ 371 Date: Aug. 25, 2011

Related U.S. Application Data
(60) Provisional application No. 61/156,115, filed on Feb. 27, 2009.

(51) Int. Cl. B65B 1/04; C08L 89/00

(52) U.S. Cl. 53/473; 106/125.1; 106/126.1; 106/132.2; 106/134.1; 53/235

(57) ABSTRACT

Soy-based modeling product. The present disclosure includes disclosure of various embodiments of soy-based modeling products. In at least one embodiment, the soy-based modeling product comprises a quantity of water, a quantity of a salt, a quantity of an oil, and a quantity of a flour, wherein at least one of the oil and/or the flour is derived from soybeans. In another embodiment, the soy-based modeling product further comprises corn starch.

### PRIORITY

The present International Patent Application is related to, and claims the priority benefit of, U.S. Provisional Patent Application Ser. No. 61/156,115, filed Feb. 27, 2009, the contents of which are hereby incorporated into the present disclosure in their entirety.

### BACKGROUND

Non-traditional soybean-based products, to compliment a selection of traditional soybean-based products, such as soy milk and soy candles, would likely be well-received by consumers. For example, a consumer may be interested in purchasing one or more soybean-based children's toys, such as, for example, a soybean-based modeling product. Such a product may be even more desirable to a consumer who has an allergy to gluten-based products, such as traditionally available modeling products, and may be even more desirable if such a product did not contain any toxic ingredients. Therefore, and if such a product would be possible to produce, it would be desirable to have a stable, gluten-free, non-toxic modeling product comprising at least one soybean-derived ingredient.

### BRIEF SUMMARY

In at least one embodiment of a soy-based modeling product of the present disclosure, the soy-based modeling product comprises a quantity of water, a quantity of a salt, a quantity of an oil, and a quantity of a flour, wherein at least one of the oil and/or the flour is derived from soybeans. In another embodiment, the quantity of an oil in the soy-based modeling product comprises soybean oil. In an additional embodiment, the quantity of a flour in the soy-based modeling comprises soybean flour.

In at least one embodiment of a soy-based modeling product of the present disclosure, the soy-based modeling product further comprises a quantity of sodium bitartrate. In another embodiment, the soy-based modeling product further comprises a quantity of corn starch. In yet an additional embodiment, the soy-based modeling product further comprises a quantity of guar gum.

In one or more exemplary embodiments of soy-based modeling products of the present disclosure, such embodiments may comprise a quantity of a colorant. In at least one embodiment, the colorant comprises food coloring. In another embodiment, the colorant comprises at least one colored drink mix.

In one or more exemplary embodiments of soy-based modeling products of the present disclosure, such embodiments may also comprise a quantity of a fragrance. In at least one embodiment, the fragrance comprises food flavoring. In another embodiment, the fragrance comprises at least one flavored drink mix.

In various embodiments of soy-based modeling products of the present disclosure, the soy-based modeling products further comprise a quantity of a preservative. In at least one embodiment, the preservative comprises sodium benzoate. In another embodiment, the preservative comprises sodium chloride.

In at least one embodiment of a soy-based modeling product of the present disclosure, the soy-based modeling product comprises a quantity of water, a quantity of a salt, a quantity of an oil, a quantity of a flour, a quantity of sodium bitartrate, a quantity of corn starch, a quantity of guar gum, and a quantity of colorant, wherein at least one of the oil and/or the flour is derived from soybeans.

In at least one method for preparing at least one soy-based modeling product of the present disclosure, the method comprises the steps of combining at least two ingredients in a receptacle, wherein at least one of the at least two ingredients is soybean-based, mixing said ingredients, heating said ingredients, and cooling said ingredients to form a soy-based modeling product. In an additional method, the step of heating said ingredients further comprises the step of mixing said ingredients. In yet another method, the step of cooling said ingredients further comprises the step of mixing said ingredients.

In at least one method for preparing at least one soy-based modeling product of the present disclosure, the method further comprises the step of placing at least a quantity of the formed soy-based modeling product in a container suitable for retail sale.

### BRIEF DESCRIPTION OF THE FIGURES

The features and advantages of the present disclosure, and the manner of attaining them, will be more apparent and better understood by reference to the following descriptions taken in conjunction with the accompanying figures, wherein:

FIG. 1 shows an image of at least some of the ingredients useful for preparing at least one embodiment of a soy-based modeling product of the present disclosure;

FIG. 2 shows an image of a combination of at least some of the ingredients useful for preparing at least one embodiment of a soy-based modeling product of the present disclosure;

FIG. 3 shows an image of the combination shown in FIG. 2, wherein the combination was heated using a heat source; and

FIG. 4 shows an image of the combination shown in FIGS. 2 and 3, wherein the combination was heated using a heat source and subsequently cooled to form an initial soy-based modeling product.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The disclosure of the present application comprises several embodiments of a soy-based modeling product for use by, for example, children as a sculpting or modeling product. In at least one embodiment of a soy-based modeling product of the disclosure of the present application, the soy-based modeling product comprises water, a salt, an oil, potassium bitartrate, and a flour, wherein at least one of the oil and/or the flour are soybean-based.

Several exemplary formulations of a soy-based modeling product of the disclosure of the present application were prepared in attempt to find at least one relatively stable and pliable soy-based modeling product. Examples 1-5, as shown below, were prepared as initial batches to determine the general suitability of soybean flour and soybean oil as soy-based ingredients.

### Example 1

| INGREDIENT | AMOUNT |
|---|---|
| Water | 2 cups |
| Soybean Flour | 2 cups |
| Sodium Chloride | 1 cup |
| Potassium Bitartrate | 1 teaspoon |
| Soybean Oil | 1 tablespoon |

### Example 2

| INGREDIENT | AMOUNT |
|---|---|
| Water | 2 cups |
| Soybean Flour | 2 cups |
| Sodium Chloride | 1 cup |
| Potassium Bitartrate | 2 teaspoons |
| Soybean Oil | 1 tablespoon |

### Example 3

| INGREDIENT | AMOUNT |
|---|---|
| Water | 1 cups |
| Soybean Flour | 2 cups |
| Sodium Chloride | 2 cups |
| Potassium Bitartrate | 3 teaspoons |
| Soybean Oil | 2 tablespoons |

### Example 4

| INGREDIENT | AMOUNT | |
|---|---|---|
| Water | 1.5 | cups |
| Soybean Flour | 3 | cups |
| Sodium Chloride | 1 | cup |
| Potassium Bitartrate | 3 | teaspoons |
| Soybean Oil | 1 | tablespoon |

### Example 5

| INGREDIENT | AMOUNT | |
|---|---|---|
| Water | 1.5 | cups |
| Soybean Flour | 3 | cups |
| Sodium Chloride | 1 | cup |
| Potassium Bitartrate | 3 | teaspoons |
| Soybean Oil | 1 | tablespoon |

Additional batches were prepared to determine whether or not the addition of rice flour to the soybean flour would generally improve the end soy-based modeling product. The first batches are represented as Examples 6 and 7 below.

### Example 6

| INGREDIENT | AMOUNT |
|---|---|
| Water | 2 cups |
| Soybean Flour | 1 cup |
| Rice Flour | 1 cup |
| Sodium Chloride | 1 cup |
| Potassium Bitartrate | 1 teaspoon |
| Soybean Oil | 1 tablespoon |

### Example 7

| INGREDIENT | AMOUNT |
|---|---|
| Water | 1 cup |
| Soybean Flour | 1 cup |
| Rice Flour | 1 cup |
| Sodium Chloride | 1 cup |
| Potassium Bitartrate | 1 teaspoon |
| Soybean Oil | 1 tablespoon |

In an attempt to generally thicken and/or cause the resulting soy-based modeling product to agglomerate, corn starch was added as an ingredient for a number of batches represented as Examples 8 through 10 below.

### Example 8

| INGREDIENT | AMOUNT |
|---|---|
| Water | 2 cups |
| Soybean Flour | 1 cup |
| Rice Flour | 1 cup |
| Sodium Chloride | 1 cup |
| Corn Starch | 1 cup |
| Potassium Bitartrate | 1 teaspoon |
| Soybean Oil | 1 tablespoon |

### Example 9

| INGREDIENT | AMOUNT |
|---|---|
| Water | 2 cups |
| Soybean Flour | 1 cup |
| Rice Flour | 1 cup |
| Sodium Chloride | 1 cup |
| Corn Starch | 2 cups |
| Potassium Bitartrate | 1 teaspoon |
| Soybean Oil | 1 tablespoon |

### Example 10

| INGREDIENT | AMOUNT |
|---|---|
| Water | 2 cups |
| Soybean Flour | 1 cup |
| Rice Flour | 1 cup |
| Sodium Chloride | 2 cups |
| Corn Starch | 2 cups |
| Potassium Bitartrate | 1 teaspoon |
| Soybean Oil | 2 tablespoons |

In a further attempt to generally thicken and/or cause the resulting soy-based modeling product to agglomerate, guar gum was added as an ingredient for at least one batch represented as Example 11 below.

### Example 11

| INGREDIENT | AMOUNT |
|---|---|
| Water | 2 cups |
| Soybean Flour | 1 cup |
| Rice Flour | 1 cup |
| Sodium Chloride | 1 cup |
| Corn Starch | 1 cup |
| Guar Gum | 1 tablespoon |
| Potassium Bitartrate | 1 teaspoon |
| Soybean Oil | 2 tablespoons |

Additional batches were prepared in attempt to incorporate a color and/or a fragrance to an exemplary soy-based modeling product. Three such batches are represented as Examples 12 through 14 below.

### Example 12

| INGREDIENT | AMOUNT | |
|---|---|---|
| Water | 1 | cups |
| Soybean Flour | 1 | cups |
| Sodium Chloride | ¾ | cup |
| Potassium Bitartrate | 1 | teaspoon |
| Soybean Oil | 2 | tablespoons |
| Flavored Drink-Mix | 2½ | tablespoons |

### Example 13

| INGREDIENT | AMOUNT | |
|---|---|---|
| Water | 1 | cup |
| Soybean Flour | 1 | cup |
| Sodium Chloride | ⅓ | cup |
| Potassium Bitartrate | 1 | teaspoon |
| Soybean Oil | 1 | tablespoon |
| Flavored Drink Mix | 2½ | tablespoons |

### Example 14

| INGREDIENT | AMOUNT | |
|---|---|---|
| Water | 1 | cup |
| Soybean Flour | 1 | cup |
| Sodium Chloride | ⅓ | cup |
| Potassium Bitartrate | 1 | teaspoon |
| Soybean Oil | 1 | tablespoon |
| Food Coloring | ½ | teaspoon |
| Food Flavoring | ½ | teaspoon |
| Additional Soybean | 2 | tablespoons |
| Flour | | |

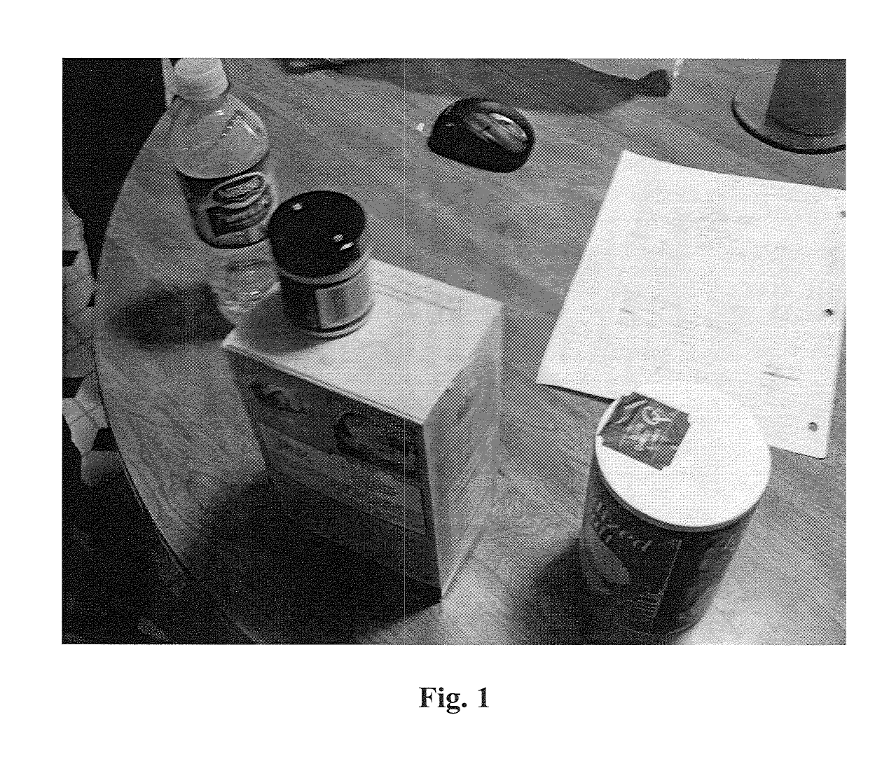

FIG. 1 shows an image of at least some of the ingredients useful for preparing at least one embodiment of a soy-based modeling product of the present disclosure. As shown in FIG. 1, exemplary ingredients may include water, potassium bitartrate, corn starch, and salt. Additional ingredients not shown in FIG. 1 but referenced herein, including, but not limited to, soybean flour, rice flour, soybean oil, guar gum, food coloring, food flavoring, flavored drink mix, and one or more preservatives are useful for the preparation of various embodiments of soy-based modeling products of the present disclosure.

Regarding the ingredients, and in many instances, more than one specific ingredient may be used in relation to the general ingredient categories referenced herein. For example, the ingredient “water” may include various forms of water, including spring water, various bottled waters, tap water, well water, deionized water, filtered/purified water, soda/carbonated water, and the like. In addition, the ingredient “water” may include one or more liquids comprising water and one or more other components that would not hinder the preparation of a soy-based modeling product of the present disclosure. For example, in place of “water,” an ingredient such as one or more water-based beverages (tea, various sodas, and the like) may be used as the ingredient “water.”

Regarding the ingredient “soybean flour” as referenced in the Examples herein, any number of soybean-based flours may be useful in the preparation of soy-based modeling products of the present disclosure. For example, “soybean flour” may comprise regularly processed soybean flour (processed from all or part of a soybean), defatted soybean flour (prepared from solvent extracted soybean flakes), full-fat soybean flour (prepared from unextracted, dehulled soybeans), low-fat soybean flour (prepared with defatted soybean flour and the addition of oil), high-fat soybean flour (prepared similar to the low-fat soybean flour, but with the addition of more oil), lecithinated soybean flour (prepared by adding lecithin to various types of soybean flour), or combinations of the same. These exemplary types of “soybean flour” are not intended to be an exhaustive list as one or more ingredients may be added to a soybean flour and continue to be useful in the preparation of soy-based modeling products as described herein. In at least one embodiment of a soy-based modeling product of the present disclosure, the soy-based modeling product may comprise defatted gluten-free soybean flour (having no trans-fats).

“Soybean oil,” as referenced herein, may include one or more formulations of soybean oil, including general crude soybean oil, or highly processed/refined soybean oil, or combinations of the same. In at least one embodiment of a soy-based modeling product of the present disclosure, the soy-based modeling product may comprise gluten-free 100% soybean oil (having no trans-fats).

The ingredient “salt” is representative of common table salt (sodium chloride, NaCl), which is commonly used among several Example batches referenced herein. However, any number of salts useful for the preparation of soy-based modeling products of the present disclosure may be used, including, but not limited to, potassium chloride, calcium chloride, or combinations of the same with and/or without sodium chloride. In at least one embodiment of a soy-based modeling product of the present disclosure, the soy-based modeling product may comprise generic iodized salt, itself comprising salt, calcium silicate, dextrose, potassium, and iodide.

A number of exemplary embodiments of a soy-based modeling product of the present disclosure comprise the ingredient “rice flour.” Rice flour, as used herein, may be used in addition to or as the sole flour ingredient in one or more soy-based modeling products. Rice flour has been selected for at least the reason that rice flour does not contain the protein gluten. In at least one embodiment of a soy-based modeling product of the present disclosure, the soy-based modeling product may comprise generic white rice flour having no additives. Along with, or in lieu of, rice flour, one or more exemplary embodiments of a soy-based modeling product may contain flour comprising corn, millet, buckwheat, millet, and sunflowers, and if those exemplary embodiments do not contain wheat, rye, or barley flour or other wheat, rye, or barley ingredients, the resulting soy-based modeling product may be considered to be “gluten-free.” Oats may or may not contain gluten, but oat flour could be used in one or more exemplary embodiments of a soy-based modeling product of the present disclosure.

“Potassium bitartrate,” as referenced herein, is commonly known as cream of tartar. In at least one embodiment of a soy-based modeling product of the present disclosure, the soy-based modeling product may comprise generic cream of tartar available at most traditional grocery stores.

“Corn starch” is also used as an ingredient in one or more exemplary embodiments of a soy-based modeling product of the present disclosure. In at least one embodiment, common corn starch is used, which is also available at most traditional grocery stores. In other embodiments, one or more types of corn starch may be used, including, but not limited to, common corn starch and/or waxy corn starch. In addition, and either along with or in lieu of “corn starch,” one or more other types of starches well known in the art, including rice starch and/or potato starch, may be used to prepare various embodiments of a soy-based modeling product of the present disclosure.

In at least one embodiment of a soy-based modeling product of the present disclosure, various colorants, flavorings, and/or fragrances may be used. In at least one embodiment, one or more common food colorings may be used as colorants to provide a color to a soy-based modeling product. In at least one additional embodiment, one or more common food flavorings may be used to provide a fragrance, and perhaps a flavor, to the soy-based modeling product. In at least one embodiment, a flavored drink mix (Kool-Aid® brand flavored drink mix, for example) may be used to add color and an scent to an exemplary embodiments of soy-based modeling products of the present disclosure. Exemplary flavored drink mixes used to add color and fragrance to a soy-based modeling product may themselves comprise sugar, fructose, citric acid, ascorbic acid, Vitamin E acetate, calcium phosphate, sodium citrate, and one or more food-grade color additives. In another embodiment, one or more gel-based food colorants may be used, with an exemplary gel-based food colorant containing corn syrup, sugar, water, modified food starch, carrageenan, sodium benzoate, citric acid, and one or more food-grade color additives. In addition to the foregoing, one or more food colorings (containing, for example, water, propylene glycol, propylparaben, and one or more food-grade color additives), concentrates, and/or extracts may be used to produce exemplary embodiments of soy-based modeling products of the present disclosure. For example, exemplary soy-based modeling products may comprise root beer concentrate (comprising caramel color, water, corn syrup, wild cherry bark extractives and other natural extractives, natural and artificial flavors, methyl salicylate, vanillin, gum Arabic, gum tragacanth, and sulfating agents), raspberry extract (comprising water, propylene glycol, alcohol, extractives of raspberry, citric acid, FD&C red 40, and natural flavoring), imitation banana extract (comprising water, alcohol, natural and artificial flavors, and FD&C yellow 5), mint extract (comprising alcohol, tincture of peppermint, water, oil of spearmint, and oil of peppermint), and watermelon flavor (comprising propylene glycol, artificial flavor, red 3, and red 40). In addition to the foregoing, one or more of the sub-ingredients, such as oil of spearmint, may be used to provide a fragrance to an exemplary soy-based modeling product of the present disclosure. While various embodiments of soy-based modeling products of the present disclosure may be used by children, for example, as a modeling product, many various embodiments contain commonly known edible materials, and as such, one or more soy-based modeling products of the present disclosure may be edible.

In at least one exemplary soy-based modeling product of the present disclosure, the soy-based modeling product comprises at least one preservative. In at least one embodiment, the preservative comprises sodium benzoate. In at least one additional embodiment, the preservative comprises potassium sorbate. Any number of commonly known and used preservatives, including, but not limited to, sodium benzoate, sodium chloride, methylparaben, propylparaben, potassium sorbate, sodium nitrite, and citric acid, may be useful to preserve one or more embodiments of a soy-based modeling product of the present disclosure.

In addition to the foregoing, one or more of several other types of ingredients may be used to produce various embodiments of a soy-based modeling product of the present disclosure. Such ingredients may include, but are not limited to, one or more preservatives, glycols, esters, mica particles, and the like, continuing to allow for the production of a useful soy-based modeling product.

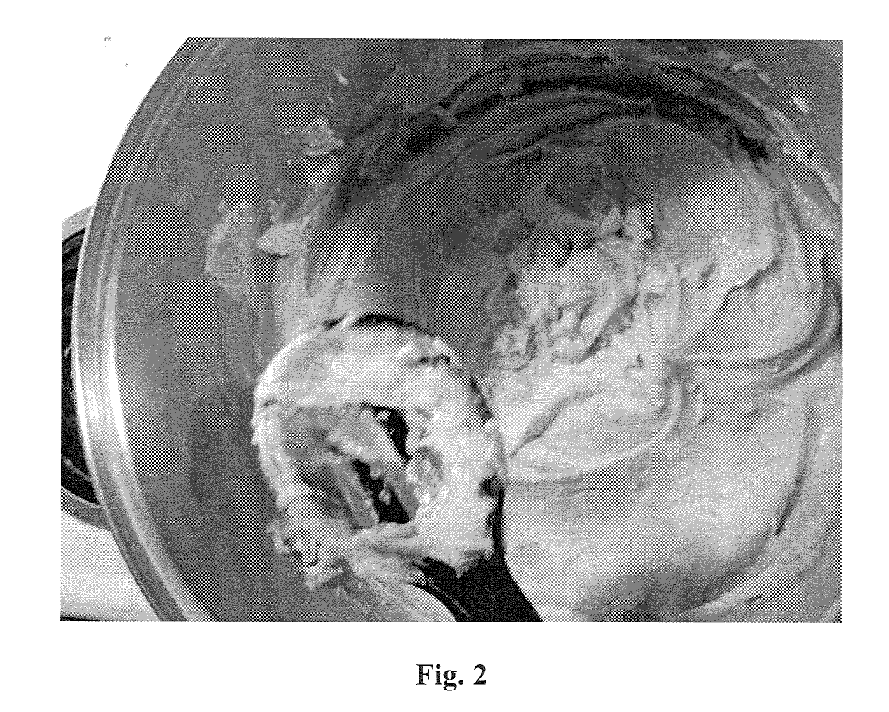

FIG. 2 shows an image of a combination of at least some of the ingredients useful for preparing at least one embodiment of a soy-based modeling product of the present disclosure. as shown in FIG. 2, at least some of the ingredients, when mixed together, form a paste that does not have the firmness quality of a desirable modeling product.

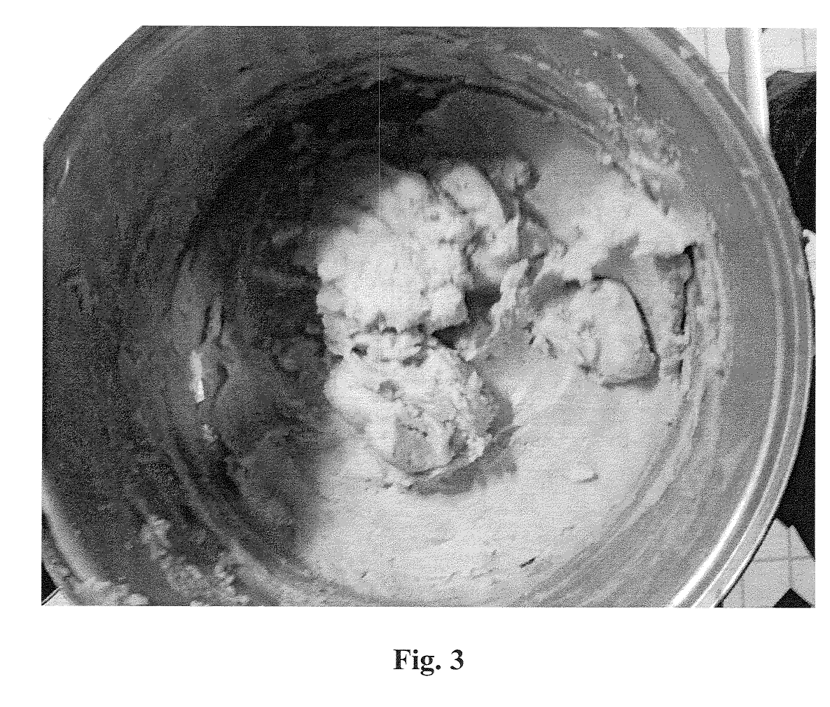

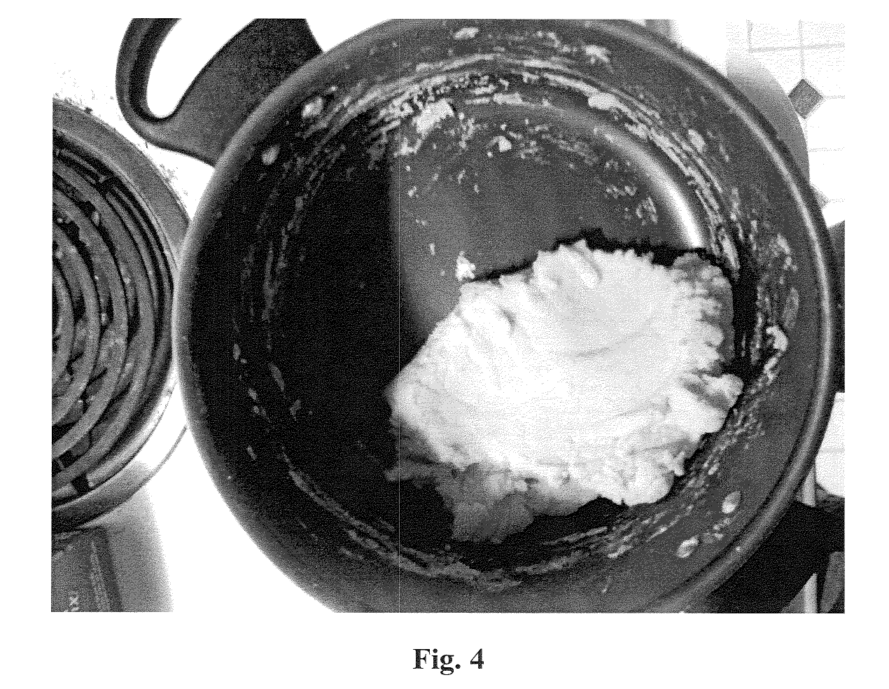

FIG. 3 shows an image of the combination shown in FIG. 2, wherein the combination was heated using a heat source. As shown in FIG. 3, the mixture of ingredients to prepare a soy-based modeling product of the present disclosure has begun agglomerating to form a product more conducive for modeling and/or shaping. FIG. 4 shows an image of the combination shown in FIGS. 2 and 3, wherein the combination was heated using a heat source and subsequently cooled to form an initial soy-based modeling product. As shown in FIG. 4, the exemplary resultant soy-based modeling product has formed a thick paste conducive for modeling and/or shaping.

In at least one embodiment, a soy-based modeling product may be prepared using the following steps. First, the desired ingredients (as referenced throughout the application) may be combined within a suitable receptacle, such as a mixing bowl, metal saucepan, etc., wherein at least one of the ingredients used to product the soy-based modeling product is soybean-based. For example, a exemplary embodiment of a soy-based modeling product may be prepared by combining water, soybean flour, soybean oil, sodium chloride, potassium bitartrate, and food coloring in a suitable receptacle, such as a saucepan.

The ingredients may be mixed within the receptacle using any number of mixing means, including, but not limited to, hand-mixing, mixing using a mechanical mixing apparatus such as a kitchen mixer, shaking, kneading, and the like, so that the ingredients become adequately mixed among one another. The ingredients may then be heated, for example in a saucepan over low-medium heat on a traditional stove, to further assist with the combination/agglomeration of the ingredients with one another. Any number of heating means may be used, including, but not limited to, heating using an electric or gas stove, an open flame, a warming apparatus such as a heated metal platform, a microwave, and/or any number of other means known in the art useful to heat a mixture of ingredients. The mixture may also be stirred, mixed, kneaded, etc., prior to, during, or after heating the mixture.

After the product has been heated to a desired temperature, the product may then be cooled and/or allowed to cool by removing the product from the heat source and/or transferring the product to a cooling apparatus such as a refrigerator, a freezer, a cooler, and/or any number of other means known in the art useful to cool a mixture of ingredients or to allow a mixture of ingredients to cool. The mixture may also be stirred, mixed, kneaded, etc., prior to, during, or after cooling the mixture.

After the product has been cooled and/or allowed to cool, the product may be shaped, if desired, to fit within a receptacle suitable for retail sale. For example, a batch of soy-based modeling product may provide enough quantity for three retail receptacles, so the product may be divided into approximate thirds, with each third of the product being placed within a suitable receptacle.

The aforementioned steps of combining, mixing, heating, and/or cooling the ingredients may be performed in connection with one another. For example, the ingredients may be added to a suitable receptacle while a mixing apparatus is used to mix the ingredients. In addition, the ingredients may be mixed/stirred at the same time heat is introduced to the mixture. Similarly, the mixture may be mixed/stirred a the same time the mixture is cooled or allowed to cool after being heated.

Furthermore, and in at least one embodiment of a method for producing a soy-based modeling product, the method comprises the steps of combining the desired ingredients within a receptacle and mixing said ingredients to form the soy-based modeling product.

While various embodiments of soy-based modeling products been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A soy-based modeling product, comprising:
a quantity of water;
a quantity of a salt;
a quantity of an oil; and
a quantity of a flour;
wherein at least one of the oil and/or the flour is derived from soybeans.

2. The soy-based modeling product of claim 1, wherein the oil comprises soybean oil.

3. The soy-based modeling product of claim 1, wherein the flour comprises soybean flour.

4. The soy-based modeling product of claim 2, wherein the flour comprises soybean flour.

5. The soy-based modeling product of claim 1, further comprising:
a quantity of sodium bitartrate.

6. The soy-based modeling product of claim 1, further comprising:
a quantity of corn starch.

7. The soy-based modeling product of claim 1, further comprising:
a quantity of guar gum.

8. The soy-based modeling product of claim 1, further comprising:
a quantity of a colorant.

9. The soy-based modeling product of claim 8, wherein the colorant is selected from the group consisting of food coloring and least one colored drink mix.

10. The soy-based modeling product of claim 1, further comprising:
a quantity of a fragrance.

11. The soy-based modeling product of claim 10, wherein the fragrance is selected from the group consisting of food flavoring and at least one flavored drink mix.

12. The soy-based modeling product of claim 1, further comprising a quantity of a preservative.

13. The soy-based modeling product of claim 12, wherein the preservative is selected from the group consisting of sodium benzoate, sodium chloride, methylparaben, propylparaben, potassium sorbate, sodium nitrite, and citric acid.

14. The soy-based modeling product of claim 1, wherein the soy-based modeling product is packaged within a container suitable for retail sale.

15. A soy-based modeling product, comprising:
a quantity of water;
a quantity of a salt;
a quantity of an oil;
a quantity of a flour;
a quantity of sodium bitartrate;
a quantity of corn starch;
a quantity of guar gum; and
a quantity of colorant;
wherein at least one of the oil and/or the flour is derived from soybeans.

16. A method for preparing at least one soy-based modeling product, the method comprising the steps of:
combining at least two ingredients in a receptacle, wherein at least one of the at least two ingredients is soybean-based;
mixing said ingredients;
heating said ingredients; and
cooling said ingredients to form a soy-based modeling product.

17. The method of claim 16, wherein the step of heating said ingredients further comprises the step of mixing said ingredients.

18. The method of claim 16, wherein the step of cooling said ingredients further comprises the step of mixing said ingredients.

19. The method of claim 16, further comprising the step of placing at least a quantity of the formed soy-based modeling product in a container suitable for retail sale.

20. The method of claim 16, wherein the at least two ingredients comprise soybean oil and at least one other ingredient.

21. The method of claim 16, wherein the at least two ingredients comprise soybean flour and at least one other ingredient.
